(19) United States
(12) Patent Application Publication
(10) Pub. No.: US 2007/0032112 A1
(43) Pub. Date: Feb. 8, 2007

(54) Self-adjustable junction connector system

(76) Inventors: Oscar Renautt, Farmington Hills, MI (US); Donald Nicholas Stacey, West Bloomfield, MI (US)

Correspondence Address: Mr. Robin W. Asher;Clark Hill PLC, 500 Woodward Avenue, Suite 3500, Detroit, MI, 48226-3435, US

(21) Appl. No.: 10/566,695

(22) PCT Filed: Jul. 30, 2004
(86) PCT No.: PCT/CA04/01425

§ 371 Date: Sep. 6, 2006

Related U.S. Application Data
(60) Provisional application No. 60/491,552, filed on Aug. 1, 2003.

(51) Int. Cl. H01R 13/64

(52) U.S. Cl. 439/246

(57) ABSTRACT

An electrical connector comprising a male housing and a female housing and electrical contacts extending therebetween when the male housing is plugged into the female housing. A shroud is reciprocatingly mounted to the male housing. When the shroud is in a retracted position, the electrical contact of the male housing is exposed to permit electrical contact with the female housing, and when the shroud is in an extended position it substantially covers the electrical contact of the male housing.

### FIELD OF INVENTION

The present invention relates to a self-adjustable junction connector system which may be used on a vehicle.

### BACKGROUND OF INVENTION

There are various locations on a vehicle where an electrical connection is desirable between two pieces of the vehicle, but is difficult to provide because the connection must be broken when the two pieces are separated during the normal use of the vehicle. Examples include potential electrical connections between a door or window and the frame of the vehicle.

Currently, in vehicles with a liftgate window situated on a liftgate module, providing electricity to the defrost system requires that wires must extend from the electrical system of the car to the liftgate window. These wires are sometimes located in the vicinity of the hinged area of the liftgate window. These wires can become worn and damaged from the everyday opening and closing of the window. In addition, they can be unsightly and present an obtrusion.

Another feature of liftgate windows is that is often considered unappealing is the handle attached directly onto the liftgate window in order to open it.

The problem with wires leading to the defrost system of the liftgate glass has been addressed by a junction connector of Yazaki-Toyota. However, this connector does not eliminate the need for handles to be used to open the liftgate window.

### BRIEF DESCRIPTION OF THE DRAWINGS

FIG. 1 is a cross-sectonal view of a male portion of a connector of a preferred embodiment of the present invention, shown in the retracted and protruding positions.

FIG. 2 is a cross-sectional view of a female portion of a connector of a preferred embodiment of the present invention.

FIG. 3 is a cross-sectional view of the male portion of FIG. 1 in an engaged position with the female portion of FIG. 2.

### DETAILED DESCRIPTION OF THE PREFERRED EMBODIMENT

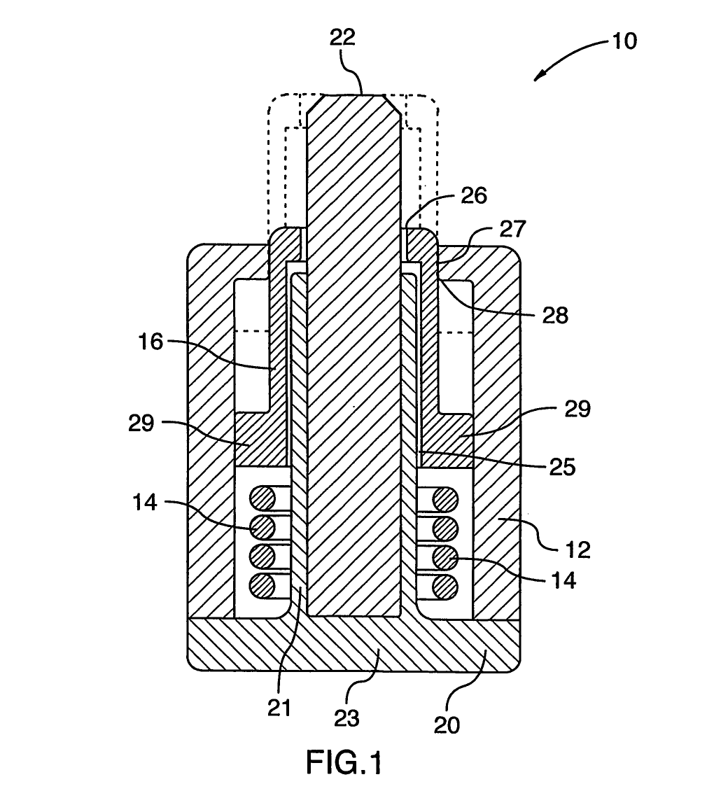

One preferred embodiment of the connector system of the present invention will now be described in detail with reference to FIGS. 1 to 3.

As shown in FIG. 1, the male connector portion comprises a housing 12, a bottom opening 23 for receiving a sliding cover 16, which cover is received through top opening 28 of housing 12. Lip 29 acts as a stop to limit the outward travel of cover 16 so as to prevent sliding cover 16 from completely exiting top opening 28. Sliding cover 16 comprises receiving chamber 27, with bottom opening 25, and opening 26 at the opposite end of opening 25. Opening 25 permits receipt of terminal pin 22 into receiving chamber 27. There may also be reinforcing material 21 extending along the sides of terminal pin 22. The reinforcing material may be made, for example, from a stiff plastic or a light metal such as aluminum. Terminal pin 22 is exposed outside of opening 26 when sliding cover 16 does not protrude through opening 28. When sliding cover 16 completely protrudes through opening 28 so that lip 29 abuts against housing 12, the cover extends the outer length of terminal pin 22 to shroud the pin. Terminal pin 22 is affixed within the stem of T-shaped housing cover 20. Reinforcing material 21 may also extend along terminal pin 22 so that it is connected to or abuts against housing cover 20. A wire (not shown) may extend from the bottom of terminal pin 22 and through the reinforcement and/or housing cover to connect to an electrical source or a section of the vehicle which requires electricity. The wire may be sealed or unsealed. Housing cover 20 covers opening 23 of housing 12. The housing cover may be unsecured to the housing, or secured with fasteners such as screws. Optionally, the housing cover may snap into the housing. Spring 14 is situated between housing cover 20 and the bottom of lip 29. Spring 14 becomes compressed when sliding cover 16 is retracted within housing 12. Therefore, sliding cover 16 is biased to protrude through opening 28, i.e., as shown as one of the positions in FIG. 1. In order to bias the sliding cover to protrude through opening 28, the spring must be at least strong enough, or have enough force, to bias the sliding cover to completely shroud terminal pin 22. When, for example, a liftgate window is in the open position and the terminals become disengaged, the sliding cover slides over the terminal pin 22 to help protect it from becoming damaged or from contacting other elements.

Housing 12, housing cover 20, and sliding cover 16 are constructed of a suitable material, such as plastic. The pin terminal 22 is made of a suitable conductive material. Optionally, it may be plated with a suitable conductive material.

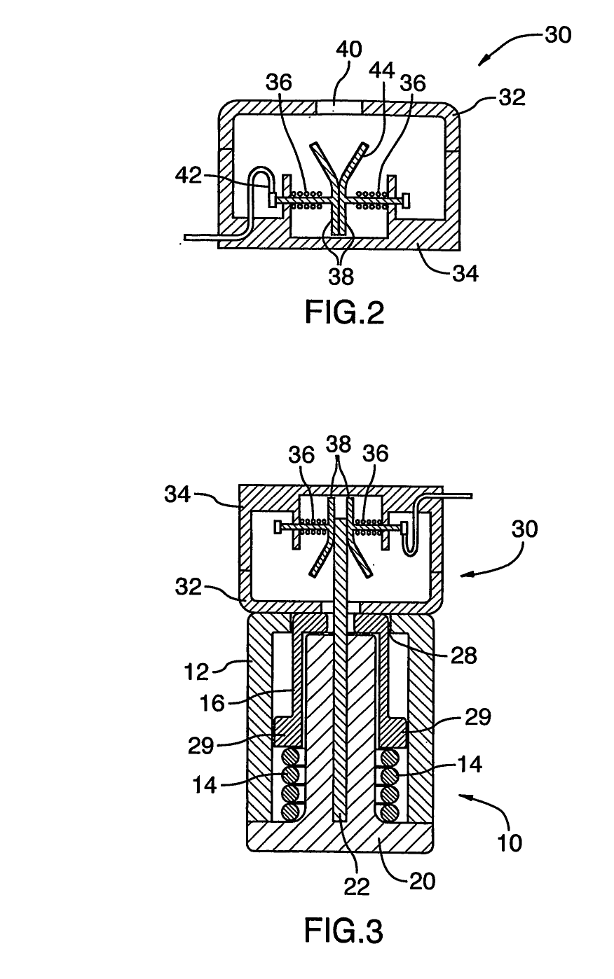

As shown in FIG. 2, the female connector portion 30 comprises an upper housing 32 and lower housing 34. Upper housing 32 has opening 40 to receive terminal pin 22 of the male connector portion 10. Lower housing 34 comprises female terminals 38. Female terminals 38 may comprise upper portions 44 which are bent towards the sides of the lower housing so that female terminals 38 together generally form a Y shape. The size of opening 40 would generally not exceed the distance between upper edges 44 of female terminals 38. The width of female terminals 38 would generally be greater than the width of terminal pin 22 to accommodate movements of terminal pin 22 due to movements of the vehicle without breaking the electrical connection. Female terminals 38 are biased towards each other by springs 36. Wire 42 is connected to the female terminals at one end, and connected to a section of the vehicle which requires electricity at the other end, such as a defrost system of the liftgate window, or to a section which provides electricity.

Upper housing 32 and lower housing 34 may be constructed of a suitable material such as plastic. The female terminals 38 are made of a suitable conductive material. Optionally, they may be plated with a suitable conductive material.

When the female connector portion connector 30 is unengaged, female terminals 38 are in touching condition and compressed by springs 36, which are loaded inside of female connector housing 30. Springs should be the same strength to insure nominal positions of the terminals. Terminals can slide in direction of the springs.

An alternative embodiment for the female connector is to have a metal plate on the bottom of the housing to supply electrical energy to the female terminals. The metal plate would be in contact with the sliding female terminals 38. This contact may be self-cleaning due to the sliding action of the female terminals 38. The metal plate would replace the need for wire 42. The metal plate would be electrically connected to a section of the vehicle which requires electricity, such as a defrost system of the liftgate window, or to a section which provides electricity.

As shown in FIG. 3, male connector portion 10 contacts female connector portion 30 through the top of housing 12 and the surface of upper housing 32. Sliding cover 16 is retractably forced into opening 28 by the interaction with the surface of upper housing 32. When the connector portions are engaged, terminal pin 22 is received between female terminals 38 in abutting electrical contact therewith. The Y-shape of the female terminals helps to guide the terminal pin 22 between the two female terminals 38 if the terminal pin 22 is off its nominal position. The nominal position would allow the male terminal pin 22 to slide between female terminals 38 without touching bent portions 44.

When in operation, female connector 30 may be located on the bottom of a liftgate glass (or any other glass or section of the vehicle, that requires defrost system or electrical connection) facing into the vehicle and male connector 10 is located on the liftgate module or other alternative mounting surfaces (sheet metal, reinforcement brackets and other) or vice-versa, if more beneficial. When the liftgate window is in a closed position, the upper housing 32 of the female connector 30 causes the retraction of sliding cover 16 to expose terminal pin 22. As it becomes exposed, terminal pin 22 enters through opening 40 and slides between female terminals 38 to create an electrical connection. The size of housing 12 of male connector portion 10 controls travel distance of the sliding cover, and therefore the housing 12 is generally of a size to accommodate a sliding cover that will fully shroud terminal pin 22 when the sliding cover is extended through opening 28. When engaged, the male and female connectors will move relatively to each other for certain distances due to movement of the gate relative to the body of the vehicle, when the vehicle is moving. Springs 36 allow sliding female terminals 38 of the female connector 30 to self-adjust as the vehicle is moving so that they follow the movement of terminal pin 22, thereby providing constant electrical connection. Female terminals will be manufactured within tolerable build variation as specified by the Original Engineering Manufacturer (OEM) to ensure constant connection with male terminal pin in cross car direction and other movements that a vehicle will make when in motion.

The connector can also act as a glass window flipper device. A glass flipper device may be devised by using the interaction of the surfaces of the male and female connectors which are interacting when the terminals are engaged. When the liftgate window is in the closed position, and the terminals are engaged, the closed window may be secured by an electrical or mechanical device, such as the ratchet of the glass latch. By increasing the strength or force of springs 14 of the male connector 10 so that it can push the weight of the liftgate window, the sliding cover will push the liftgate glass for a specified distance and will hold the glass in the open position, until the glass can be operated manually. Springs of a force suitable to lift a window according to this embodiment of the invention will be required. The glass window flipper device will be capable of pushing the glass outwardly to the point where the forces of the glass struts will set the glass to the fully open position. The glass flipper device may be activated by release of the glass latch or other locking mechanisms.

We claim:

1. An electrical connector comprising:
a female housing having an electrical contact therein;
a male housing having a distal end receivable into the female housing, and having an electrical contact extending from the distal end to contact the electrical contact of the female member when the male housing is received in a closed position into the female housing; and
a shroud reciprocatingly mounted to the male member, movable between a retracted position and an extended position, wherein when in the retracted position the electrical contact of the male housing is exposed to permit said electrical contact with the contact of the female member, and when in the extended position the shroud extends to substantially cover the electrical contact of the male member.

2. The connector of claim 1, wherein the shroud is biased towards the extended position such that when the male housing is moved out of said closed position, the shroud moves into the extended position.

3. An electrical connector comprising:
a first member having a distal end, and an electrical contact extending therefrom;
a second member having first and second contacts, at least one of the contacts being an electrical contact, and at least one of the contacts being movable with respect to the other and biased in a first direction theretowards; wherein the electrical contact of the first member is movable a second direction, generally orthogonal to the first, into a closed position, between the contacts of the second member by insertion therebetween, in which said movable contact is biased thereagainst and in which the electrical contacts of the members are in electrically conductive contact with each other, and the electrical contacts are free to move in a third direction orthogonal to the first and second directions with the electrical contacts of the members are in electrically conductive contact with each other.

4. The connector of claim 3, wherein said movable contact is biased toward the other by means of a spring bearing against the movable contact.

5. An electrical connector comprising:
a pair of housing members movable with respect to each other in a first direction along a first axis to engage each other in a closed electrically conductive position;
wherein, a first of the members comprises a release member mounted thereto for reciprocating movement along the axis, and biased in the first direction and in abutment with the second of housing member to force the housing members apart when released from the closed position.

6. An electrical connector comprising:
a first housing having an electrical contact;
a second housing having a distal end with an electrical contact extending therefrom to contact the electrical contact of the first housing when the first and second housings are assembled with the contacts in electrically conductive contact with each other; and
a shroud reciprocatingly mounted to the second housing, movable between a retracted position and an extended position, wherein when in the retracted position the electrical contact of the second housing is exposed to permit said conductive contact with the contact of the first housing, and when in the extended position the shroud extends to substantially cover the electrical contact of the second housing.
